(19) United States
(12) Patent Application Publication
(10) Pub. No.: US 2009/0271521 A1
(43) Pub. Date: Oct. 29, 2009

(54) METHOD AND SYSTEM FOR PROVIDING END-TO-END CONTENT-BASED LOAD BALANCING

(75) Inventor: Roy F. Brabson, Raleigh, NC (US)

Correspondence Address: STRATEGIC PATENT GROUP, P.C., P.O. BOX 1329, MOUNTAIN VIEW, CA, 94042, US

(73) Assignee: International Business Machines Corporation, Armonk, NY (US)

(21) Appl. No.: 12/108,682

(22) Filed: Apr. 24, 2008

(51) Int. Cl. G06F 15/16

(52) U.S. Cl. 709/228

(57) ABSTRACT

Methods and systems for providing end-to-end content-based load balancing are described. A Transmission Control Protocol (TCP) connection is accepted from a client and a request is received from the client. The request is processed, a target stack is selected, and the TCP connection is transferred to the selected target stack such that the client and selected target stack maintain an end-to-end TCP connection. In an exemplary embodiment, the request can be processed in a TCP kernel. In another preferred embodiment, the TCP connection can include TCP data packets and the request can include request data packets. The TCP connection transfer can be performed by replaying the TCP data packets and the request data packets to the selected target stack.

### BACKGROUND OF THE INVENTION

A load balancer is a server that manages an internet protocol (“IP”) address and port. The load balancer manages a number of servers, referred to as “target stacks.” When the load balancer receives a request for an IP address and/or port on a target stack that it is managing, the load balancer makes a selection from the target stacks capable of processing the request and forwards the request to the selected target stack. The metrics that a load balancer uses to select a target stack varies among implementations. Some load balancers use a simple round-robin metric, providing an even distribution of new requests among all target stacks. Other load balancers may factor the capacity and health of the target stacks into the selection process.

As long as the target stacks are all capable of handling the same requests received by the load balancer, conventional load balancing algorithms can be used. However, this is not always the case. In large server farms, it is sometimes necessary to partition the applications and data used to generate responses to queries among multiple servers. As such, a given target stack may only be able to process a subset of the overall requests received from a client.

A “content-based” load balancer is designed to handle these and other types of configurations. When a content-based load balancer receives a new connection from a client, it accepts the connection and, for Transmission Control Protocol (TCP), completes a 3-way handshake. The client then sends the initial query, which is examined by the load balancer. The load balancer then selects a target stack capable of handling the specific request from the set of available targets. Since the load balancer has terminated the connection with the client, it uses a separate connection to the target stack (either a long-running connection or a new connection) to relay the client's request.

There can be disadvantages to conventional content-based load balancers. First, for each client connection, the load balancer may terminate the TCP connection. This means the load balancer may be required to perform all TCP processing (e.g., the 3-way handshake) whenever it communicates with the client (e.g., manage windows, segmentation/reassembly, and so on). Additionally, the load balancer may be required to maintain one or more TCP connections to each target server, which can entail TCP processing overhead. Termination and creation of these TCP connections can adversely affect load balancer performance when traffic is great.

Another potential disadvantage of conventional content-based load balancers is that the load balancer may be required to process all inbound and outbound traffic between the client and the target stack. For example, when the request is received from the client, the load balancer can be required to receive the client request and forward it to the target stack. Likewise, the load balancer can be required to receive responses from the target server and forward the responses over the TCP connection to the client. This intermediate processing may not only reduce the capacity of the load balancer, but also increase latency between the client and the target stack.

### BRIEF SUMMARY OF THE INVENTION

Methods and systems for providing end-to-end content-based load balancing are described. A Transmission Control Protocol (TCP) connection is accepted from a client and a request is received from the client. The request is processed, a target stack is selected, and the TCP connection is transferred to the selected target stack such that the client and selected target stack maintain an end-to-end TCP connection.

In an exemplary embodiment, the request can be processed in a TCP kernel. In another preferred embodiment, the TCP connection can include TCP data packets and the request can include request data packets. The TCP connection transfer can be performed by replaying the TCP data packets and the request data packets to the selected target stack.

### BRIEF DESCRIPTION OF SEVERAL VIEWS OF THE DRAWINGS

FIG. 1 illustrates an exemplary embodiment of a system for providing end-to-end content-based load balancing.

FIG. 2 illustrates an exemplary embodiment of a process for providing end-to-end content-based load balancing.

FIG. 3 illustrates an exemplary embodiment of transferring a TCP connection from a load balancer to a target stack using a “replay” mechanism.

### DETAILED DESCRIPTION OF THE INVENTION

Processes and systems for providing end-to-end content-based load balancing are described. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

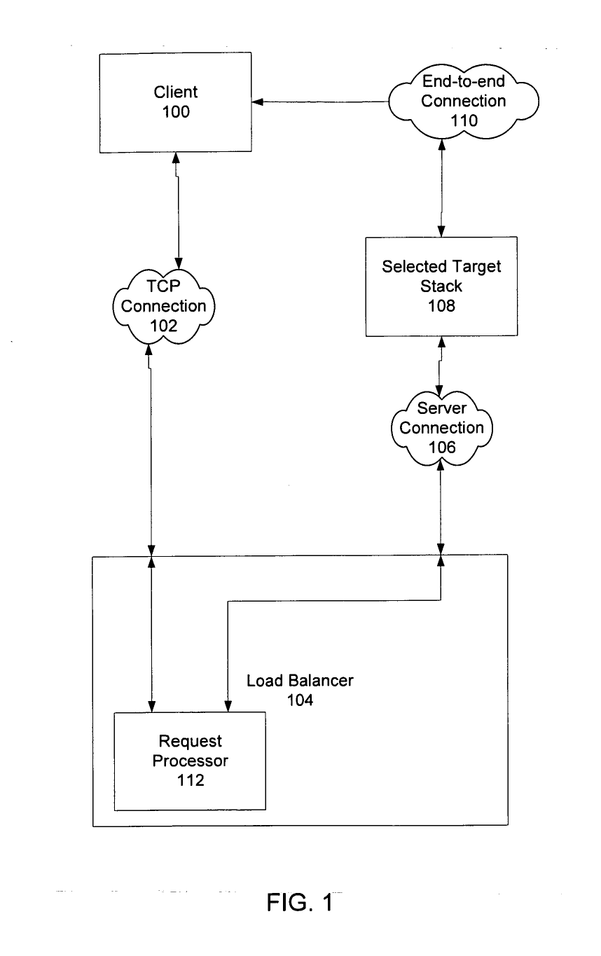

FIG. 1 illustrates an exemplary embodiment of a system for providing end-to-end content-based load balancing. The system includes a client 100, a load balancer 104, and a target stack 108. The client 100 and the load balancer 104 can be connected via a Transmission Control Protocol (TCP) connection 102. Likewise, the load balancer 104 and the target stack 108 can be connected through server connection 106. The server connection 106 can be implemented using any method of establishing a network connection between a load balancer and a server, including a TCP connection. The TCP connection 102 and the server connection 106 can be any suitable wired or wireless connection.

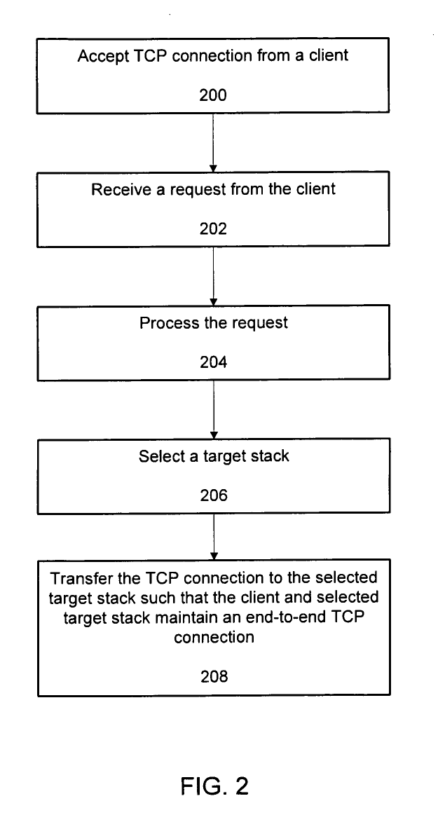

The load balancer 104 is configured to accept the TCP connection 102 from the client 100. Although only one client is shown in FIG. 1, in some embodiments multiple clients can be utilized, and each client can have its own TCP connection in such embodiments. The load balancer 104 can receive a request from the client 100. The request can be, for example, a request for data associated with a uniform resource indicator (“URI”) associated with a web site stored on a server managed by the load balancer 104. The request can be transmitted using TCP connection 102, and the load balancer 104 can be configured to process the request. The load balancer 104 can include a request processor 112, which performs the processing of the request. Processing the request generally entails examining the content of the request such that the load balancer 104 can locate a target stack capable of providing the requested content to the client 100 and decide which stack to transfer the request. Processing the request is described with greater detail below, in the discussion of FIG. 2. As described below, request processor 112 can process the request within a TCP kernel on the load balancer 104, or within an application in a user space on load balancer 104.

The load balancer 104 can then select a target stack, which can be one of many target stacks within the system in some embodiments. The load balancer can then transfer the TCP connection 102 to the selected target stack 108 such that the client 100 and the selected target stack 108 maintain an end-to-end TCP connection 110. In doing so, load balancer 104 substantially behaves as a “proxy-less” content-based load balancer. Transferring the TCP connection is described with greater detail below, in the discussion of FIG. 2.

The system shown in FIG. 1 can therefore advantageously avoid having the load balancer terminate the TCP connection and maintain a separate TCP connection to the target server for each request made by the client 100. Data packets from the client 100 to the selected target stack 108 may still be routed through the load balancer, but in such embodiments the routing generally requires less processing than if the load balancer 104 were acting as a proxy, and may only involve IP forwarding logic. This IP forwarding logic can, in some embodiments, be offloaded to an adapter, which can further reduce the processing burden on the load balancer 104.

Furthermore, data packets from the selected target stack 108 to the client 100 do not need to be routed through the load balancer 104. Since the TCP connection between the client 100 and the selected target stack 108 is end-to-end, the load balancer 104 does not manage any parameters of the TCP state (e.g., window size, segmentation/reassembly, checksums, etc.). This can greatly increase the capacity of the load balancer 104 (i.e., the number of client requests that may be processed) while reducing latency between the client 100 and selected target stack 108.

FIG. 2 illustrates an exemplary embodiment of a process for providing end-to-end content-based load balancing. The process shown in FIG. 2 can be performed using the load balancer 104.

A TCP connection is accepted from the client 100 (block 200) and a request is received from the client 100 (block 202) as described hereinabove. The request can be processed (block 204), for example, by the request processor 112, for the purpose of selecting a target stack (block 206). In an exemplary embodiment, the content of the request is processed within a TCP kernel. This can either be done using exits invoked from within the kernel, or by including the decision logic within the kernel itself. In other embodiments, the request may be processed by an application that resides in a user-space on the load balancer 104. The application can examine the content of the request and direct the TCP kernel to transfer the request to the selected target stack 108.

When a target stack is selected, the TCP connection 102 is transferred to the selected target stack such that the client and selected target stack maintain the end-to-end TCP connection 110 (block 208). As is discussed below, the load balancer 104 can then update its connection table so future request packets received from the client 100 can be forwarded to the selected target stack 108. The TCP connection 102 can include TCP data packets, and the request can include request data packets. In an exemplary embodiment, the transferring the TCP connection 102 can be performed by replaying the TCP data packets and the request data packets to the selected target stack 108. While other methods can be utilized (e.g., marshalling the TCP state at one stack and transferring it out-of-band to the target stack), replaying the TCP data packets and the request data packets has the advantage of requiring minimal changes at the target stack for the transfer of the TCP connection 102. In an exemplary embodiment, a TCP sequence number can be transferred to the selected target stack along with the TCP data packets. This can be done to ensure that the target stack uses the same sequence number used by the load balancer 104 when the TCP connection 102 with the client 100 was established.

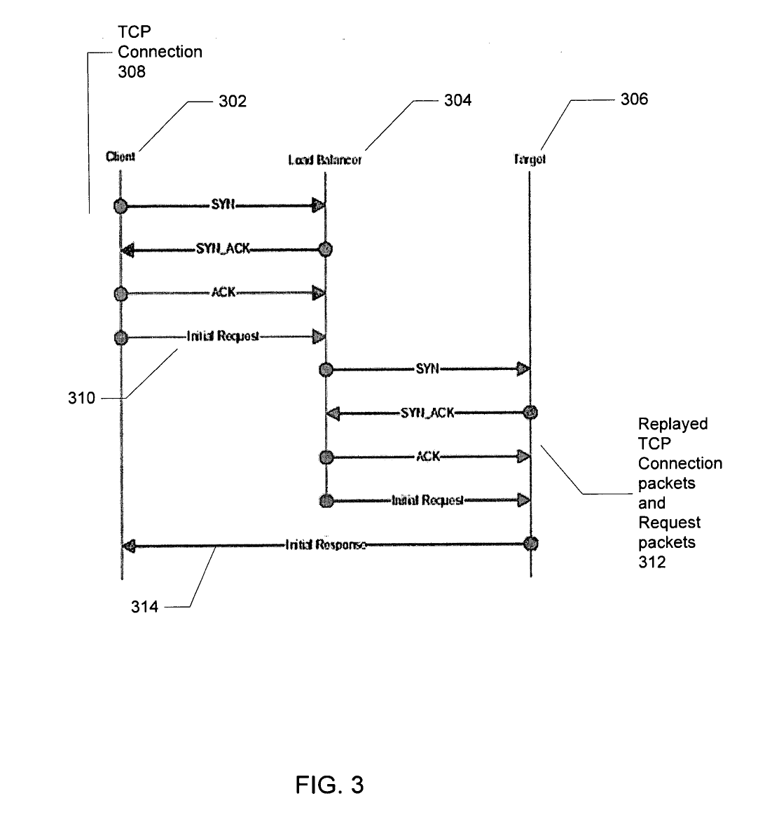

FIG. 3 illustrates an exemplary embodiment of transferring a TCP connection from a load balancer to a target stack using a “replay” mechanism. FIG. 3 shows data packets traveling between a client 302, a load balancer 304, and a target stack 306. A synchronize packet (“SYN”) is sent from the client 302 to the load balancer 304, an acknowledgement and synchronization packet (“SYN_ACK”) is returned by the load balancer 304 to the client 302, and an acknowledge packet is sent by the client to the load balancer 304. These steps form the “3-way handshake” for a TCP connection 308 between the client 302 and the load balancer 304.

The client 302 can send initial request data packets 310 to the load balancer 304. The load balancer 304 can process the initial request data packets 310 as described hereinabove and select a target stack 306. The load balancer 304 can then replay the packets that have been received from the client 302, including the 3-way handshake and the initial request data packets 312, to the selected target stack 306. Replaying the 3-way handshake can be advantageous because doing so may reduce the need to adapt the selected target stack 306 to accept the transfer of the TCP connection (e.g., in some embodiments, the selected target stack 306 may need to be adapted to receive the TCP sequence number). In an alternative embodiment, the load balancer 304 can replay only the SYN packet to the selected target stack 306, instead of replaying the entire 3-way handshake. Such an embodiment can be advantageous because it can reduce the amount of processing overhead for the load balancer 304 when transferring the TCP connection. In another alternative embodiment, the ACK packet may be replayed to the selected target stack 306 as well as the SYN packet.

After the target stack 306 has established the replayed TCP connection and the initial request data packets 312, the target stack 306 can process the packets and utilize the packets to re-create the TCP state that exists at the load balancer 304. Target stack 306 can then return initial response data packets 314 to client 302. As shown in FIG. 3, initial response data packets 314 can be transferred to the client 302 without being routed through the load balancer 304. Such a configuration can be advantageous because it can reduce the amount of processing performed by the load balancer 304. However, in an alternative embodiment, initial response data packets 314 may be routed through the load balancer 304.

In an exemplary embodiment, the load balancer 304 can include a connection table, which can identify the target stack associated with each client. The connection table can be updated such that future requests made by the client 302 may be transferred to the selected target stack. The load balancer 304 can then discard all TCP state data maintained for the TCP connection 308 because the TCP connection is maintained end-to-end between the client 302 and the target server 306.

In an exemplary embodiment, the invention is implemented in software, which includes but is not limited to firmware, resident software, microcode, etc. The invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is mainly described in terms of particular systems provided in particular implementations. However, one of ordinary skill in the art will readily recognize that this method and system will operate effectively in other implementations. For example, the systems, devices, and networks usable with the present invention can take a number of different forms. The present invention will also be described in the context of particular methods having certain steps. However, the method and system operate effectively for other methods having different and/or additional steps not inconsistent with the present invention.

A method and system for providing end-to-end content-based load balancing has been described. The present invention has been described in accordance with the embodiments shown, and one of ordinary skill in the art will readily recognize that there could be variations to the embodiments, and any variations would be within the spirit and scope of the present invention. For example, the present invention can be implemented using hardware, software, a computer readable medium containing program instructions, or a combination thereof. Software written according to the present invention is to be either stored in some form of computer-readable medium such as memory or CD-ROM, or is to be transmitted over a network, and is to be executed by a processor. Consequently, a computer-readable medium is intended to include a computer readable signal, which may be, for example, transmitted over a network. Accordingly, many modifications may be made by one of ordinary skill in the art without departing from the spirit and scope of the appended claims.

We claim:

1. A method for providing end-to-end content-based load balancing comprising:
accepting a Transmission Control Protocol (TCP) connection from a client;
receiving a request from the client;
processing the request;
selecting a target stack; and
transferring the TCP connection to the selected target stack such that the client and selected target stack maintain an end-to-end TCP connection.

2. The method of claim 1 wherein the TCP connection comprises TCP data packets and the request comprises request data packets, wherein the transferring the TCP connection is performed by replaying the TCP data packets and the request data packets to the selected target stack.

3. The method of claim 1 wherein the method is performed using a load balancer.

4. The method of claim 3 wherein the load balancer comprises a TCP state, wherein the transferring the TCP connection is performed by marshalling the TCP state and transferring the TCP state to the selected target stack.

5. The method of claim 1 wherein the request is processed within a TCP kernel.

6. The method of claim 3 wherein the load balancer comprises a user-space, wherein the request is processed within an application residing within the user-space.

7. The method of claim 1 further comprising transferring a TCP sequence number to the selected target stack.

8. The method of claim 3 wherein the load balancer comprises a connection table, further comprising updating the connection table such that future requests made by the client are transferred to the selected target stack.

9. A system for providing end-to-end content-based load balancing comprising:
a load balancer, wherein the load balancer is configured to accept a Transmission Control Protocol (TCP) connection from a client, receive a request from the client, process the request, select a target stack, and transfer the TCP connection to the selected target stack such that the client and the selected target stack maintain an end-to-end TCP connection.

10. The system of claim 9 wherein the TCP connection comprises TCP data packets and the request comprises request data packets, wherein the transferring the TCP connection is performed by replaying the TCP data packets and the request data packets to the selected target stack.

11. The system of claim 9 wherein the load balancer further comprises a TCP state, wherein the transferring the TCP connection is performed by marshalling the TCP state transferring the TCP state to the selected target stack

12. The system of claim 9 wherein the load balancer further comprises a TCP kernel, wherein the request is processed within the TCP kernel.

13. The system of claim 9 wherein the load balancer further comprises a user-space, wherein the request is processed within an application residing within the user-space.

14. The system of claim 9 wherein the load balancer is further configured to transfer a TCP sequence number to the selected target stack.

15. The system of claim 9 wherein the load balancer further comprises a connection table and is further configured to update the connection table such that future requests made by the client are transferred to the selected target stack.

16. An executable software product stored on a computer-readable medium containing program instructions for providing end-to-end content-based load balancing, the program instructions for:
accepting a Transmission Control Protocol (TCP) connection from a client;
receiving a request from the client;
processing the request;
selecting a target stack; and
transferring the TCP connection to the selected target stack such that the client and selected target stack maintain an end-to-end TCP connection.

17. The executable software product of claim 16, wherein the TCP connection comprises TCP data packets and the request comprises request data packets, wherein the transferring the TCP connection is performed by replaying the TCP data packets the request data packets to the selected target stack.

18. The executable software product of claim 16, wherein the program instructions are executed using a load balancer.

19. The executable software product of claim 16, wherein the request is processed within a TCP kernel.

20. The executable software product of claim 18, wherein the load balancer comprises a user-space, wherein the request is processed within an application residing within the user-space.

21. The executable software product of claim 18, wherein the load balancer comprises a TCP state, wherein the transferring the TCP connection is performed by marshalling the TCP state transferring the TCP state to the selected target stack.

22. The executable software product of claim 16, further comprising program instructions for transferring a TCP sequence number to the selected target stack.

23. The executable software product of claim 18, wherein the load balancer comprises a connection table, further comprising updating the connection table such that future requests made by the client are transferred to the selected target stack.
